(19) United States
(12) Patent Application Publication
(10) Pub. No.: US 2023/0105303 A1
(43) Pub. Date: Apr. 6, 2023

(54) GEARCASE SYSTEM FOR MOTOR AND WHEEL SET ASSEMBLY

(71) Applicant: Transportation IP Holdings, LLC, Norwalk, CT (US)

(72) Inventors: Scott Leute, Erie, PA (US); Uday Karmarkar, Erie, PA (US); Robert Armbruster, Erie, PA (US)

(21) Appl. No.: 17/450,053

(22) Filed: Oct. 5, 2021

(51) Int. Cl. F16H 57/029; B61C 9/46

(52) U.S. Cl. CPC F16H 57/029; B61C 9/46; F16H 2057/02034

(57) ABSTRACT

Systems and methods are provided for a gearcase of a motor and wheel set assembly configured to enclose a gear set, including a first case element, a second case element configured to mate with the first case element to contain lubricating oil for at least the gear set and a pinion, and a rubberized seal. In one example, a system may include permanent rubberized seals sealing an opening configured to receive the pinion, an interface between the first case element and the second case element and a bearing cap.

### TECHNICAL FIELD

Embodiments of the subject matter disclosed herein relate to systems for enclosing a gear set coupled with a traction motor and wheel assembly.

### DISCUSSION OF ART

Vehicles may include traction motors that are positioned at one or more axles for supplying motive power from the motor to a wheel or wheel set via a gear set. Such a motor and wheel assembly (sometimes referred to as a “combo”) may use a two part gearcase to enclose the gear set, axle shaft bearing, and motor pinion end rotor shaft bearing. The gearcase may contain lubrication oil for the enclosed gear set and bearings.

Gearcases may include seals for the prevention of oil leakage. Seal locations may include the pinion entry point, the axle entry and outlet points, and the split line between the two gearcase halves. The pinion and axle entry point seals may include “O-ring” types that may be subject to failure modes including pinching, cutting and deformation. The split line seal method may include the application of a bead of a curing viscus sealant, e.g. room-temperature-vulcanizing (RTV) silicone, placed between the flange faces along the gearcase halves split line. The split line seal may be subject to failure modes relating to impaired sealant adhesion to the gearcase halves and placement error in the silicone application resulting in gaps in the seal. When a seal fails, insufficiently lubricating the gears and bearings can lead to motor seizing and other failures such as locked axle condition.

In general, the gearcase assembly onto the combo is a blind process with large, awkwardly shaped parts. Reassembly at the time of service may present challenges for cleanliness. The component tolerances and resulting assembly tolerances are also fairly large, which may limit the types of seals that are used on the pinion and axle areas and their respective gearcase interfaces with the pinion bore, axle bore, and mounting bolt locations.

### BRIEF DESCRIPTION

It may be desirable to have a gearcase system that provides improved assembly and sealing with simplified systems. In one embodiment, a gearcase system is configured to enclose a gear set with a first case element, second case element configured to mate with the first case element to contain lubricating oil for at least the gear set and a pinion, and a rubberized seal.

### BRIEF DESCRIPTION OF THE DRAWINGS

FIGS. 1A AND 1B show isometric and cross-sectional views, respectively, of a motor and wheel set assembly including a gearcase assembly enclosing a gear set, axle bearing and motor pinion end bearing, according to an embodiment of the present disclosure.

FIGS. 2A-B show detail views of the rubberized bearing cap seal.

FIGS. 3A-C show detail views of the rubberized gearcase and gearcase split line seal.

FIGS. 4A-G show detail views of the rubberized gutter seal.

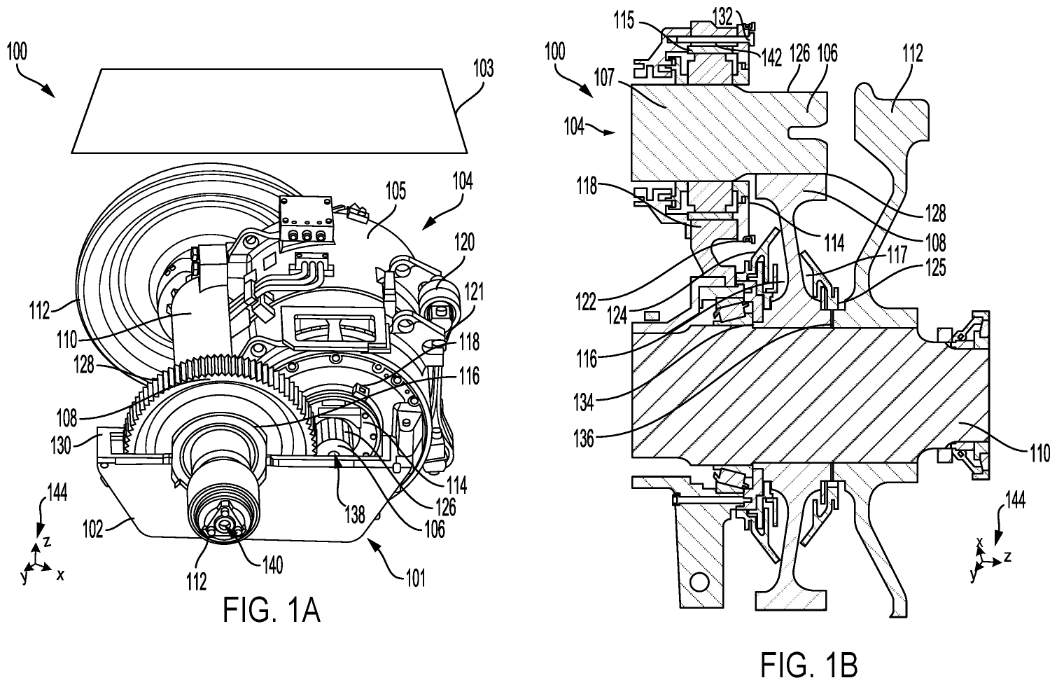

FIGS. 1-4 are shown approximately to scale.

### DETAILED DESCRIPTION

Embodiments of the application are disclosed in the following description, and may relate to a case system (sometimes referred to as a “gearcase”) configured to enclose one or more of, or combinations of, a gear set, pinion bearings, and axle bearings of a combo assembly. Such a gearcase system enclosing a combo assembly may be positioned in a stationary generator set or a vehicle system. The vehicle system, as an example, may be a locomotive system, off-highway vehicle, etc. Suitable gearcase systems may include rubberized variants of the combo assembly, gearcase, and sealing components and may include a rubberized bearing cap seal, rubberized split line seal, and rubberized gutter seal to replace seals of the existing assembly. Aspects disclosed herein may separately and in combination reduce or eliminate known leak paths, and related system failures, such as lubricant leakage via the axle shaft and pinion shaft entry points and the split line of the gearcase. In the example of the axle and pinion shaft entry points, pinching, deformation and cutting failure modes typical of separately manufactured “O-ring”-type seals may be reduced by seals integral to the combo assembly that work in combination with seal surfaces modified to channel and direct lubricant to the desired parts and sump. Gearcase seal failures related to silicone adhesion and placement error may be mitigated by a sealing and encasement system that reduces the reliance on skilled silicone placement and component cleanliness at the time of manufacture and assembly.

A technical effect for one embodiment of a rubberized combo gearcase is the reduction of lubricant leakage due to seal failure. In one embodiment, a “w-shaped” pinion seal may be replaced with a rubberized bearing cap to produce a seal profile that is permanently attached to the bearing cap. Rubberizing the bearing cap may offer a fixed seal that will reduce gross dislocation and distortion during the assembly process to minimize the pinching, deformation, and cutting failure modes. In one embodiment, the gearcase split line seal is also a rubberized component approach where the seal material is adhered to one gearcase half that has been prepared with the specific groove to establish this new sealing bead. A benefit of this seal is a robust and stationary bead on one case half, which will reduce the reliance on skilled silicone replacement and component cleanliness at the time of assembly. In one embodiment, a single gutter seal may be positioned in the gearcase interior at each the axle bore entry and the axle bore outlet. The gutter seal may be a molded annular member formed of a single piece of polyurethane with channels and protrusions that interact with the internal chamber of the gearcase to collect and return lubricant to the sump and occlude known leak paths. When operating as a system, the rubberized combo gearcase may achieve the combinatory effect of preventing leaks, while keeping lubricant in place, and increasing the overall longevity and optimal functioning of the system components.

FIGS. 1A and 1B show an embodiment of a combo assembly and gearcase system. In the illustrated example FIGS. 1A and 1B, a combo assembly 100 is depicted. An embodiment of the combo assembly includes a traction motor 104 of a traction vehicle such as an electric or diesel-electric locomotive and a wheel axle 110 rotatably captured between the pair of vehicle wheels 112 (one wheel is not shown).

In the isomeric view of FIG. 1A, the motor embodiment includes a motor housing 105 and a link 120 coupled to the motor housing via mount 121. At one end of the motor, the motor rotor is drivingly coupled to the axle by means of suitable torque amplifying gearing comprising a relatively small diameter pinion gear 106 on the motor shaft and a relatively large diameter axle gear 108 on the axle. The pinion gear is adjacent to the bearing cap 114, which is fastened to the pinion plate 118 encasing of the motor. The pinion gear 106 and pinion teeth 126 rotate the axle gear 108 via axle gear teeth 128. During the operation of the gear set, the traction motor drives the pinion gear by rotating the pinion (107 in 1B) coupled to the pinion gear about the axis of rotation 138. Due to the engagement of the gear teeth, the pinion gear rotates the axle gear about an axis of rotation 140. The axle gear is coupled to the axle that rotates with the axle gear. The axle of the axle gear is coupled to a first wheel and a second wheel that rotates with the axle. The wheels engage a surface to move the machine. In one embodiment, the first wheel and the second wheel are locomotive wheels. An axis system 144 is given in FIGS. 1A and 1B.

An output of the gear set is housed in a gearcase 101 consisting essentially of two parts. In one embodiment, there is a first case element 102 and a second case element 103, shown schematically, which is shaped to mate the first case element. In one embodiment, the first case element is a bottom case element and the second case element is a top case element. A gearcase flange 130 is depicted along the perimeter of the first case element. During gearcase assembly, the two gearcase elements make face sharing contact at the flange and a plurality of fasteners join the gearcase closed around the gear set.

In the illustrated example FIG. 1B, a cross sectional view of the combo assembly 100 is depicted. A section of the traction motor 104 is shown enclosing the pinion 107. The bearing cap 114 encloses a bearing 115 disposed in a bearing cavity 142 to rotatably support the shaft. The bearing cap is affixed to the pinion plate 118 by a plurality of fasteners 132. Example fasteners may include bolts or clamps. The bearing cap is rubberized circumferentially with a bearing cap seal 122. An inboard gutter 116 and outboard gutter 117 of the gearcase are sealed circumferentially about the axle shaft entry 134 and axle shaft outlet 136 via an inboard gutter seal 124 and an outboard gutter seal 125. The rubberized gearcase components and seals in combination enclose the gear set and motor pinion, forming a method to retain lubricant for the contained elements.

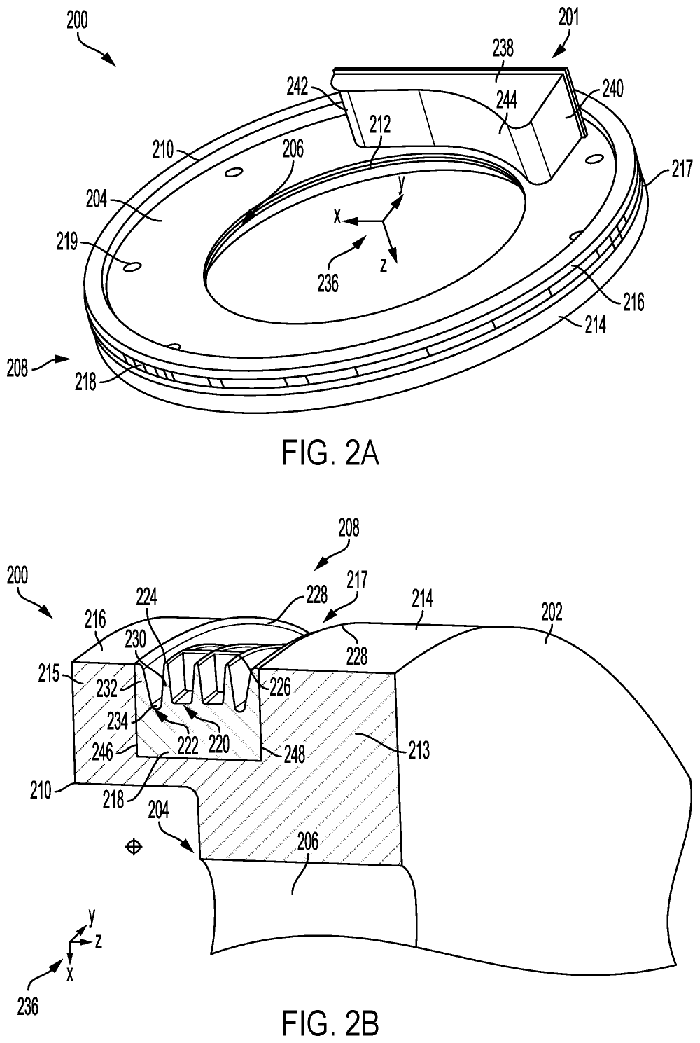

FIGS. 2A-2B show perspective views of an embodiment of a rubberized bearing cap that may replace the existing, separately molded, “w” shaped seal for the gearcase entry point of the pinion shaft. The rubberized seal is permanently joined with the bearing cap. It is not a separate rubberized ring. During manufacturing of the bearing cap, a rugged sealing element is embedded into a recession of the bearing cap. An example embodiment of the seal may be hydrogenated acrylonitrile butadiene rubber (HNBR) which is made integral to the steel bearing cap in the manufacturing process. An advantage of rubberizing the bearing cap may be reducing misalignment that may occur when the gearcase hits a piece of the seal. The integral seal reduces pulling away from the bearing cap and forces the gearcase to center. This may allow uniform and repeated installation for the duration of its service life. When used in the disclosed combo assembly gearcase system, the rubberized bearing cap seal may contain lubricant in the gearcase, preventing lubricant loss, and minimizing the migration of contaminants into the gearcase. In FIGS. 2A-2B, an axis system 236 is depicted.

In FIG. 2A, an embodiment of a rubberized bearing cap 200 is depicted as an annulus. An inboard face 202 (see 2B) is parallel to an outboard face 204. A protruding, pocked shaped lubricant tray 201 is coupled to the outboard face 204. The lubricant tray has a first face 238 that is parallel to the outboard face of the bearing cap. Two sidewalls are perpendicular to the first face and outboard face, e.g. a larger sidewall 240 and a relatively smaller sidewall 242, and are joined by the downward sloping floor 244 to form a pocket that collects and directs excess lubricant. A shaft face 206 forms the inner ring of the annulus and features radial grooves 212 that interlock with the pinion shaft. A split line face 208 forms the outer ring of the annulus and is parallel to the shaft face. Running circumferentially about the outboard face is a flange 210. The flange forms a lip where the split line face meets the outboard face. A radial groove 217 divides the split line face asymmetrically into an outboard split line wall face 216 and a relatively wider inboard split line wall face 214. The rubberized bearing cap features a plurality of through-holes 219 defined by the inner cylindrical surface and an opening on the inboard face and opening on the outboard face. The bearing cap may be bolted to the pinion plate and motor housing via the through-holes. The rubberized bearing cap seal 218 is described further below.

Turning now to FIG. 2B, a view from the interior radius of the rubberized bearing cap 200 is depicted in detail. The rubberized bearing cap seal 218 is a permanent rubber sealing element molded into the radial groove 217. The groove is recessed into the split line face 208 of the bearing cap and walls are formed by the recess and adjacent surfaces. The outboard split line wall 215 is parallel to the inboard split line wall 213 and the walls are separated by the recess of the radial groove. The outboard split line wall is shaped by the outboard split line wall face 216, the flange 210 and the seal-facing surface 246. The inboard split line wall is shaped by the inboard split line wall face 214, the inboard face 202, and the seal-facing surface 248. The rubberized integral bearing cap seal is approximately the same thickness as the inboard split line wall and twice as thick as the outboard split line wall.

The outermost rings of the seal form a pair of radial lips 228. The radial lips are the furthest projecting protrusions of the molded seal. Each radial lip forms the peak of each of two parallel v-shaped trough walls 232. One v-shaped trough wall is in face sharing contact with the outboard split line wall. The other v-shaped trough wall is in face sharing contact with the inboard split line wall. There are three interior ridges 230 that run parallel to, and laterally separate, the v-shaped trough walls. The peak 224 of each interior ridge is lower than the radial lips of each v-shaped trough wall. A pair of parallel v-shaped troughs 222 are formed between each of the v-shaped trough walls and the outermost interior ridge. At the base of each v-shaped trough is a gutter 234, which is the deepest recession of the rubberized bearing cap seal. The three interior ridges are bisected by a cross piece 226 that forms an interior grid of flat bottom dams 220. The grid is two dams wide and runs radially about the seal. All ridges, troughs, and dams are radially molded into the circumference of the bearing cap seal.

The interface between a bearing cap and gearcase may be a common seal failure point. The rubberized bearing cap, when used in conjunction with the gearcase combo assembly system, minimizes leakage along the split line wall and gearcase interface with the parallel radial lips of the molded seal. Compression of the lips causes the seal to arc up on both sides of the split line. An embodiment of the seal is soft rubber optimized for the compression at the meeting point between the gearcase and the bearing cap.

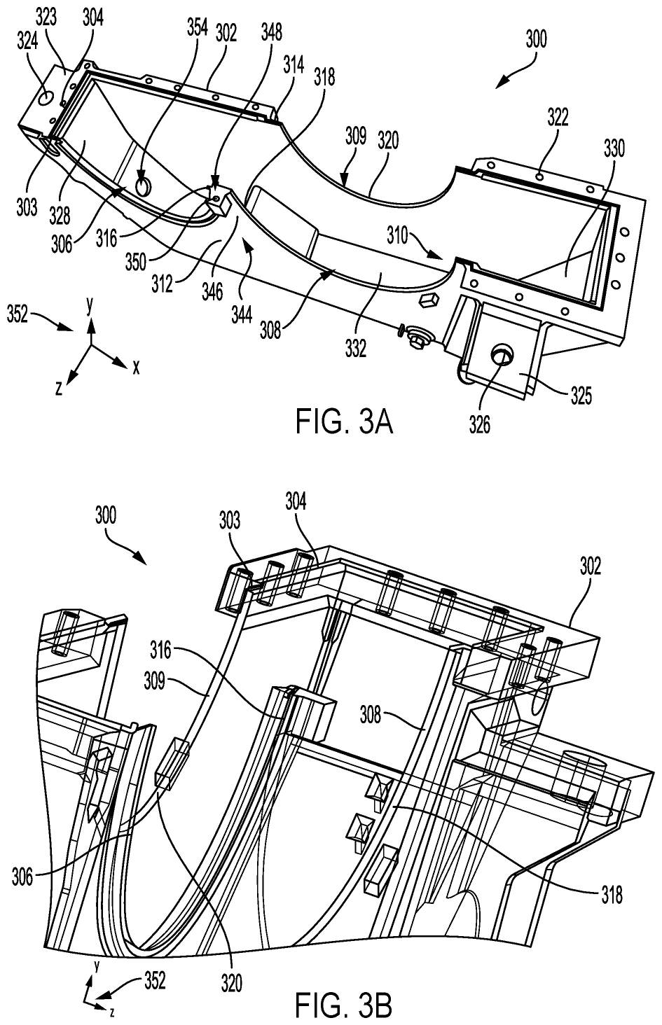

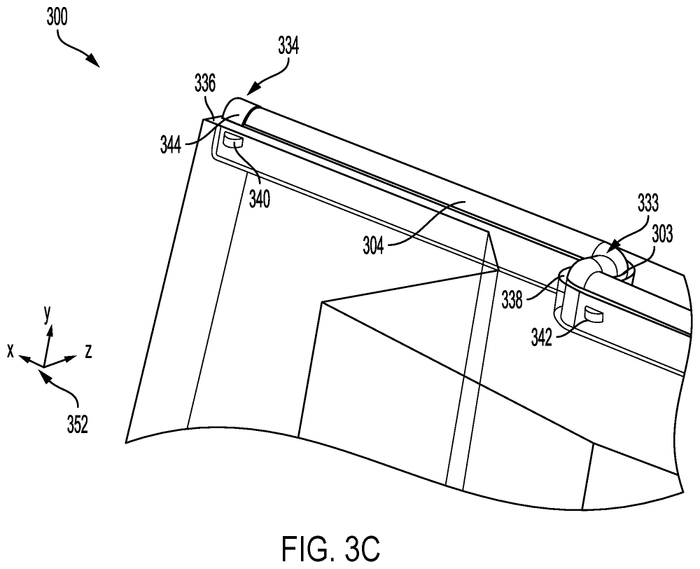

FIGS. 3A-3C show an embodiment of rubberized gearcase that may replace the traditional gearcase split line seal. The gearcase works as a system with the bearing cap seal and gutter seals to retain lubricant in the gearcase and maintain lubrication of the housed components. The gearcase features a robust stationary rubber bead seal that is molded separately and embedded into the grooved perimeter where the two parts of the gearcase come together, the split line. The seal may include molded protrusions and molded tabs, which, in conjunction with permanent affixing to the gear case, further reduces leakage and simplifies the gearcase installation process. A preferred material class for the gearcase split line seal may be a compression set, thermal-, weight-, and oil-resistant rubber such as fluoroelastomer (FKM). In one embodiment, the gearcase may be manufactured from steel. FIGS. 3A-3C feature an axis system 352.

FIG. 3A shows an example first case element 300 of the rubberized gearcase. A second case element is not shown and may be shaped to mate the first case element. The first case element is a pocket-shaped container formed by an inboard exterior sidewall 312 parallel to the outboard exterior sidewall 314. Perpendicular to the interior and exterior sidewalls are a set of sidewalls 328, 330 that join with a floor 332, and the exterior sidewalls to form the container. The floor may have a lubricant drainage port 354 and may be stopped or drained by inserting or removing a plug. The cavity of the container is the gearcase interior 310. The gearcase interior may contain additional seals of the gearcase system, the gear set, and bearings, and may function as a sump for lubricating oil when coupled in the system.

The inboard exterior sidewall features two half-circle cutouts. The first half-circle cutout is the pinion inlet 306 where the pinion shaft enters the gearcase. The bearing cap seal sits on the radially protruding bearing cap seal receiving ridge 316 of the pinion inlet. The second half-circle cutout is the axle inlet 308 where the wheel axle shaft enters the gearcase. The inboard gutter seal pinches over the inboard gutter seal receiving rim 318 of the axle inlet. The outboard exterior sidewall features a single half-circle cutout where the wheel axle shaft exits the gearcase via an axle outlet 309. The outboard gutter seal pinches over the outboard gutter seal receiving rim 320 of the axle outlet.

Along the perimeter of the first case element is a flange 302. The flange is a molded upper edge of the first case element sidewalls. The flange projects out from the sidewall exteriors except at the cutouts where the pinion and axle shafts enter and exit the gearcase. The flange includes a groove 303. Molded into the groove is a rubberized split line seal 304. The gearcase features a plurality of through-holes for fastening the upper and lower gearcase halves. There is a plurality of relatively small through-holes 322 opposite the seal running the length of the flange. The plurality of through-holes 322 are formed by cylindrical negative space punched through the flange. A bracket 323 protrudes from sidewall 328 with at least one through-hole 324 for a larger fastener. Bracket 325 protrudes from the flange of the inboard exterior sidewall with a through-hole 326 for an additional larger faster. The inboard exterior sidewall features an inverted spandrel 346 between the pinion inlet 306 and wheel axle inlet 308 formed by where the bearing cap seal receiving ridge 316 meets with the inboard gutter seal receiving rim 318. The inverted spandrel is capped with a box-shaped protrusion 348 with a cylindrical through-hole 350 for an additional gearcase fastener.

FIG. 3B shows a close view of the first case element 300 of the rubberized gearcase. The relatively shallow recess in the flange 302 forms the groove 303 into which the rubberized split line seal 304 is pressed and adhered. The convex edge of the rubberized split line seal protrudes beyond the groove, and may be compressed to form a pressurized, mesial seal when the second case element and first case element are fastened at the plurality of through-holes. The pinion inlet 306 is shown and the bearing cap seal receiving ridge 316. The wheel axle inlet 308 and wheel axle outlet 309 are shown featuring the gutter seal inboard receiving rim 318 and the gutter seal outboard receiving rim 320.

FIG. 3C shows a close view of the rubberized split line seal 304 that contours through the groove 303 of the first case element 300. A plurality of bulbs 333 and end geometries 334 are molded into the seal and may improve sealing at the gearcase interfaces. Example interfaces are shown such as an end interface 336 and the corresponding seal end geometry with a relatively larger diameter tip 344. A joint interface 338 may be sealed by the molded bulb of the seal at the joint.

The gearcase is manufactured to specifically accommodate the seal. When the molded rubber seal is integrated with the gearcase, a plurality of concave tab receptacles 340 in the gearcase receive a plurality of molded tabs 342 that project from the surface of the seal. The tab receptacles are on one side only of the gearcase. The corresponding molded tabs are on the matched side of the rubber seal. In this way, the tab receptacles act as guides and ensure the seal is seated for appropriate compression.

When coupled in a system, the gearcase and sealing elements seal the first case element to the second case element with a first rubberized seal, the rubberized split line seal. A second rubberized seal, the rubberized bearing cap seal, seals the traction motor pinion within the gear case. The rubberized gutter seals (described below) seal the axle bore within the gearcase. The combined effect is enclosing the gear set and the traction motor pinion by sealing the first case element to the second case element along a single split line to contain lubricating oil for the enclosed components.

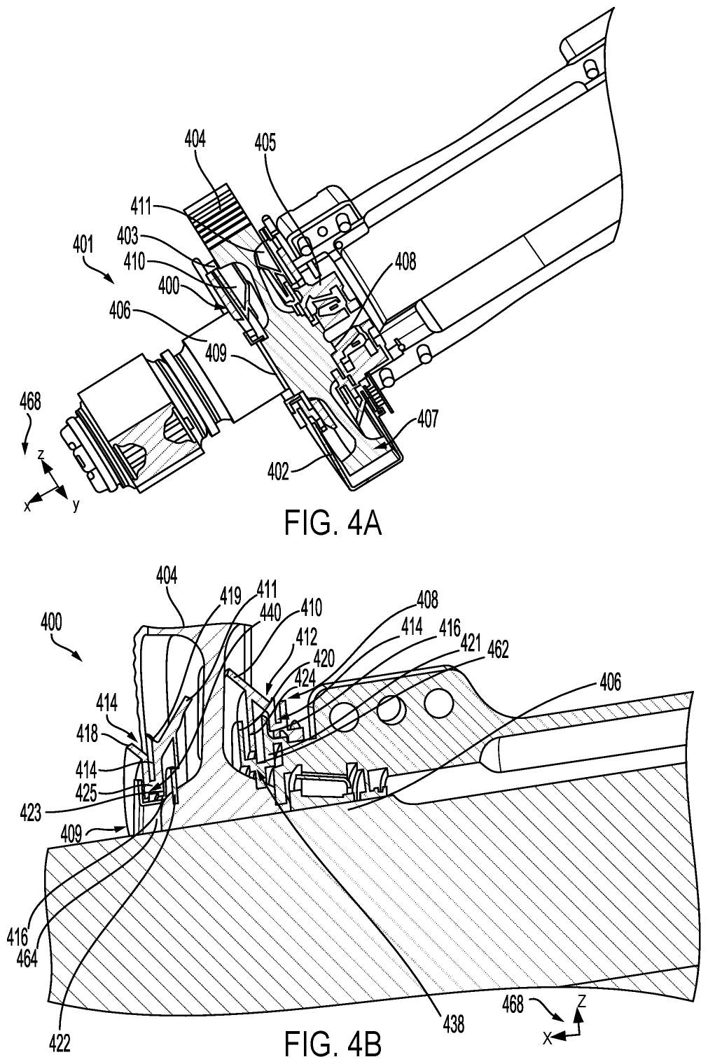

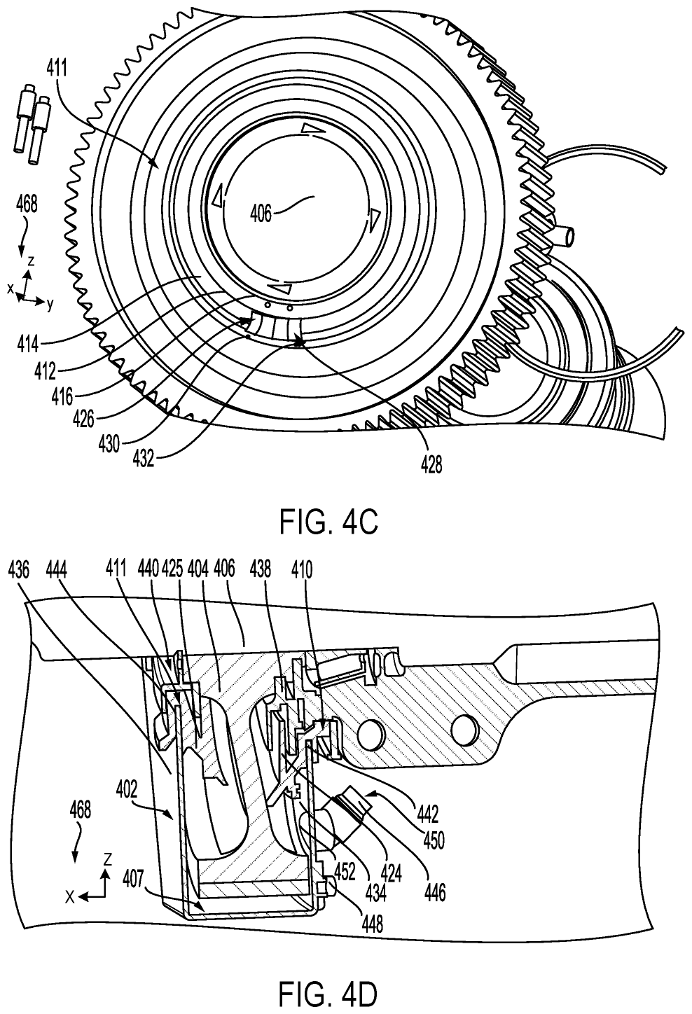

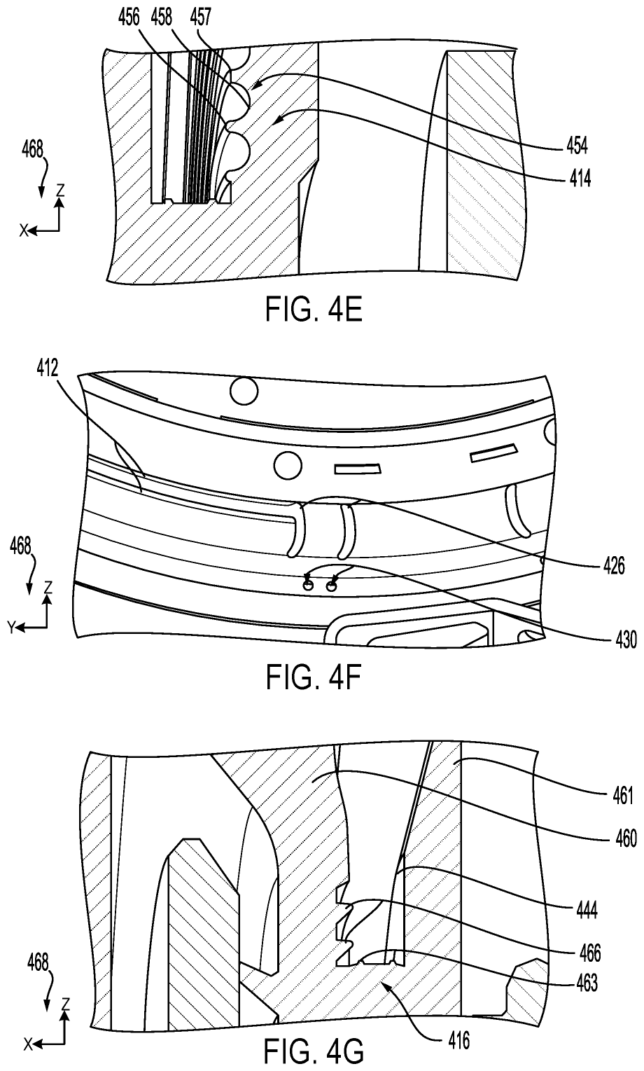

FIGS. 4A-4G show an embodiment of a gutter seal system 400 within a gearcase 401 and an axis system 468. FIG. 4A shows the general placement of the gutter seal system within the gearcase comprising a first case element 402 and second case element 403. As part of the combo assembly system, the gearcase contains the axle gear 404 and pinion gear 405, their bearings, and lubricating oil within the gearcase interior 407. When the gearcase interior contains lubricant, it may function as a sump. The gutter seal system occludes the leakage of lubricant from the gearcase that may exit the gearcase via leak paths such as the radial surface the wheel axle 406 at axle inlet 408 and axle outlet 409. The gutter seal system comprises two asymmetrical one-piece annular rubber seals circumferential to the axle. The two gutter seals are shown as an inboard gutter seal 410 and an outboard gutter seal 411. In an embodiment of the system, the gutter seal is formed from molded polyurethane.

FIG. 4B shows a cross section of an embodiment of the gutter seal system 400 with the gearcase removed. Segments of the two gutter seals are shown in place circumferential about the axle 406 on either side of the axle gear 404. The axle inboard receiving recess 438 and the axle outboard receiving recess 440 are shown with asymmetrical recesses and protrusions. The axle inboard receiving recess is a trough-shaped recess formed by a first and second inboard protrusion 420, 421 and a base 462 that receives a radial interior protrusion 424 of the inboard gutter seal 410. The interior protrusion slots into the recess of the rim. The axle outboard receiving recess 440 is a trough-shaped recess formed by a first and second outboard protrusion 422, 423 and a base 464. A radial exterior protrusion 425 of the outboard gutter seal 411 slots in the recess of the rim.

The gutter seal includes a plurality of radially concentric dynamic lip seals 416. An example of the dynamic lip seal 416 is at the axle surface contact of the inboard protrusion 421, and the dynamic lip seal 416 at the axle surface contact of the outboard protrusion 423. The ridges of the dynamic lip seal may increase sealing pressure and reduce lubricant leakage. The dynamic lip seals are described in more detail below. The gutter seal may include a plurality of drain-back channels 414. The lower lip 418 and upper lip 419 of the drain-back channels interface with the gearcase wall to wipe, collect, and direct lubricant to the channel. The gutter seal may include a pair of gutter channels 412, which in the system with the drain-back channels, also directs lubricant away from the gearcase walls to the sump.

FIG. 4C shows an embodiment of the outboard gutter seal 411 positioned circumferentially about the wheel axle 406 with gearcase removed. The inner most rings of the annular gutter seal are the dynamic lip seals 416. Further out from the lip seals is the pair of gutter channels 412. Moving out from the gutter channels are the drain-back channels 414. The drain-back channels are a series of concentric rings about the circumference of the annulus. The drain-back channels and the gutter channels terminate at split impressions in the seal, the paired drain channels 426, 428. The paired drain channels are nearly vertical and terminate at 6 o'clock below at paired drains 430, 432. The system of drain-back channels, gutter channels and paired channels and drains work in the system to move oil away from the split line and gearcase walls toward the sump.

FIG. 4D depicts a cross section view of the gutter seals 410, 411 installed between the walls of the first case element 402 and the axle 406. Examples of the lower gearcase inboard wall 434 and lower gearcase outboard wall 436 are shown. The inboard gutter seal slides over the gutter seal inboard receiving rim 442. The radial interior protrusion 424 of the gutter seal is slotted into the trough of the axle inboard receiving recess 438. The outboard gutter seal 411 slides over the gutter seal outboard receiving rim 444. The radial exterior protrusion 425 of the gutter seal slots into the trough of the axle outboard receiving recess 440. When installed in the gearcase combo assembly system, the gutter seals act as sleeves around the axle, sealingly compressed between the gearcase and the axle receiving recesses. In this way, the gutter seals are pressurizingly seated between the troughs of the axle recesses and the rims of the gearcase.

The gearcase system may include a lubricant fill port 446 and a lubricant drain port 448. In one embodiment, the lubricant fill port is shown as a cylindrical tube with a pluggable exterior inlet 450 for lubricant that drains into the gearcase interior 407 via the interior outlet 452. In one embodiment, the drain port is shown as a pluggable drain hole.

Turning to FIG. 4E, a detail view the gutter seal with a plurality of concentric drain-back channels 414 is shown. An example first channel 454 is formed by a first channel ridge 456, second channel ridge 457, and a concave semicircle 458. Lubricant is collected along the gearcase wall and directed to the sump of the gearcase interior via the drain-back channels.

FIG. 4F depicts a detail view of an embodiment of the paired gutter channels 412. The gutter channels are a parallel concentric pair of recessions molded into the surface of the seal. The paired gutter channels terminate at the drain channel 426, which is a pair of channels that empty into the paired drains 430. Lubricant is collected along the gearcase wall, directed through the gutter channels to the sump of the gearcase interior via the system of gutter drain channels and gutter drains.

A detail view of an example section of dynamic lip seals 416 is shown in FIG. 4G. The dynamic lip seals are a series of radial major ridges and minor ridges along the interior wall 460 and exterior wall 461 of the gutter seal. The dynamic lip seals make contact with the surfaces of the axle ridges. In one embodiment, the dynamic lip seals increase the pressurization of the seal at the interface between the gutter seal and the axle ridges via contact at the minor ridges 463 and major ridges 466.

FIGS. 1A-4G show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 1-4G are drawn approximately to scale, although other dimensions or relative dimensions may be used.

As used herein, an element or step recited in the singular and preceded with the word “a” or “an” should be understood as not excluding plural of said elements or steps, unless such exclusion is explicitly stated. Furthermore, references to “one embodiment” of the invention do not exclude the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, the term “approximately” is construed to mean plus or minus five percent of the range unless otherwise specified.

1. A case system configured to enclose a gear set, comprising a first case element;
a second case element configured to mate with the first case element to contain lubricating oil for at least the gear set and a pinion;
and a rubberized seal.

2. The case system of claim 1 wherein the rubberized seal seals an opening configured to receive the pinion.

3. The case system of claim 1 wherein the rubberized seal seals an interface between the first case element and the second case element.

4. The case system of claim 1 further comprising a bearing cap including a groove for the rubberized seal.

5. The case system of claim 4 wherein the rubberized seal is permanently attached to the bearing cap.

6. The case system of claim 1 further comprising a traction motor and the gear set.

7. The case system of claim 6 wherein the case system includes a case, the case consisting essentially of a two parts, the two parts being the first case element and the second case element.

8. The case system of claim 7 wherein the first case element and the second case element are joined at a single split line.

9. The case system of claim 8 wherein the first case element includes a flange at the split line.

10. The case system of claim 1 wherein the rubberized seal seals the first case element to the second case element, the case system further comprising a second rubberized seal to seal the pinion.

11. The case system of claim 1 further comprising a locomotive wheel coupled to the gear set.

12. A method of forming a case system enclosing a gear set, comprising:
permanently affixing a first rubberized seal to a first case element and a second rubberized seal to one of the first case element and a second case element, the second rubberized seal positioned to seal a traction motor pinion; and
enclosing the gear set and the traction motor pinion by sealing the first case element to the second case element to contain lubricating oil for at least the gear set.

13. The method of claim 12 further comprising coupling an output of the gear set to a vehicle wheel.

14. The method of claim 13 wherein the vehicle wheel is a locomotive wheel.

15. The method of claim 14 wherein the first case element is a bottom case element and the second case element is a top case element.

16. A case system configured to enclose a gear set, comprising a first case element;
a second case element configured to mate with the first case element to contain lubricating oil for at least the gear set and a pinion;
a first rubberized split line seal;
a second rubberized bearing cap seal; and
a rubberized gutter seal.

17. The case system of claim 16 wherein the rubberized gutter seal includes two asymmetrical one-piece annular rubber seals with molded protrusions and channels.

18. The case system of claim 16 wherein the first rubberized split line seal includes a rubber bead seal with molded tabs and bulbs.

19. The case system of claim 16 wherein the second rubberized bearing cap seal includes a permanent rubber sealing element.
